(19) United States
(12) Patent Application Publication
(10) Pub. No.: US 2005/0269364 A1
(43) Pub. Date: Dec. 8, 2005

(54) Inflatable seal for bin discharge system

(76) Inventor: Rayce D. Gibson, Nixa, MO (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/116,590

(22) Filed: Apr. 28, 2005

Related U.S. Application Data
(60) Provisional application No. 60/566,992, filed on Apr. 30, 2004.

(51) Int. Cl. B67B 7/00; G01F 11/00; B67D 5/06

(52) U.S. Cl. 222/181.1

(57) ABSTRACT

An inflatable seal for a bin discharge system including a bulk container and a discharge station. The inflatable seal including a tube and a fluid. The tube defines an inflation chamber and is secured about a periphery of an interface between an opening of the bulk container and an opening of the discharge station. The fluid is adapted to be introduced into the inflation chamber. A quantity of the fluid within the inflation chamber is adjustable to selectively form a seal between the bulk container and the discharge station.

### CROSS-REFERENCE TO RELATED APPLICATIONS

This patent application claims priority under 35 U.S.C. §119(e) to U.S. Provisional Patent Application No. 60/566,992, filed Apr. 30, 2004, which is incorporated herein by reference.

### BACKGROUND

The present invention generally relates to a bin discharge system, and more particularly, to an inflatable seal for a bin discharge system between a discharge station and a storage container.

Intermediate bulk containers (IBCs), also referred to as tote bins, are commonly used for storing bulk goods, in particular, for storing granulated powdered bulk products. The bulk containers are typically generally rectangular in shape and, as such, are easily handled by a forklift truck and easily stacked or stored for subsequent use. For these and other reasons, the use of bulk containers or tote bins is a rapidly growing manner of storing and shipping dry bulk materials.

Typically, tilt discharge stations are configured to receive the bulk containers and to receive the contents of the bulk containers via a transition hopper, which can be equipped with a screw conveyor, a vibratory feeder, a vacuum conveying system, or other material handling device. More specifically, dry goods contained within a bulk container exit the bulk container via a lower opening aligned with a transition hopper opening such that the dry bulk materials exit the opening of the bulk container and flow into the transition hopper for subsequent distribution. A seal is typically included between the bulk container and the transition hopper around the periphery of the openings of the bulk container and the transition hopper to generally decrease the amount of dry bulk materials lost during transition from the bulk container to the transition hopper.

However, due to various manufacturing tolerances, defects, etc., conventional seals often allow at least a portion of the powdered, dust, or granulated product to escape near the interface between the bulk container and the transition hopper. Dust escaping from the bulk container and transition hopper interface is disbursed into the surrounding environment. The presence of dust or powder in the manufacturing environment often times is collected on mechanical devices positioned relatively near the tilt discharge station. In some instances, the collection of dust on the mechanical devices creates mechanical device maintenance problems that need be shut down and repaired, thereby, resulting in lost manufacturing time. In addition, residual amounts of the dust or powder are often retained in the air where they may be inhaled or otherwise encountered by workers, which can present workers with various health and safety problems.

The release of dust from the interface between the bulk container and the transition hopper is further aggravated due to vibration of the bulk container and/or transition hopper. In particular, due to difficulties that have long been encountered in removing finely divided powder or dust bulk materials from storage bins, vibration has typically been introduced to the bulk container or transition hopper to prevent the individual particles from packing or clinging together in a manner that interferes with the free flow of the dust particles from the bulk container into the transition hopper. While the vibration does facilitate free flow of bulk materials from the bulk container and into the transition hopper, it also stirs the amount of dust or powdered particles interacting with the interface between the bulk container and the transition hopper. The additional stirring of dust particles to the periphery of the bulk container and transition hopper interface generally increases the quantity of dust particles escaping the seal and entering the environment of the mechanical equipment and associated workers.

For these and other reasons, a need exists for the present invention.

### SUMMARY

One aspect of the present invention relates to an inflatable seal for a bin discharge system including a bulk container and a discharge station. The inflatable seal including a tube and a fluid. The tube defines an inflation chamber and is secured about a periphery of an interface between an opening of the bulk container and an opening of the discharge station. The fluid is adapted to be introduced into the inflation chamber. A quantity of the fluid within the inflation chamber is adjustable to selectively form a seal between the bulk container and the discharge station.

### BRIEF DESCRIPTION OF THE DRAWINGS

Embodiments of the invention will be described with respect to the figures, in which like numbers denote like elements, and in which:

FIG. 1 is an exploded, perspective view of one embodiment of a bin discharge system including a bin in an upright position.

FIG. 2 is a side view of the bin discharge system of FIG. 1.

FIG. 3 is a top view of the bin discharge system of FIG. 1.

FIG. 4 is a perspective view of the bin discharge system of FIG. 1 with the bin in a tilted position.

FIG. 5 is a plan view of one embodiment of a transition hopper of the bin discharge system of FIGS. 2 and 3 with an inflatable seal provided on a face of the transition hopper.

FIG. 6A is a cross-sectional view taken along the line 6-6 of FIG. 5 illustrating one embodiment of the inflatable seal in a deflated state.

FIG. 6B is a cross-sectional view taken along the line 6-6 of FIG. 5 illustrating one embodiment of the inflatable seal in an inflated state.

FIG. 7 is a cross-sectional view taken along the line 7-7 of FIG. 5.

FIG. 8 is a schematic illustration of one embodiment of a control system for an inflatable seal of a bin discharge system according to the present invention.

FIG. 9 is a flow chart illustrating one embodiment of a process for discharging goods from a bin of a bin discharge system according to the present invention.

### DETAILED DESCRIPTION

In the following detailed description, reference is made to the accompanying drawings which form a part hereof and in which is shown by way of illustration specific embodiments in which the invention may be practiced. In this regard, directional terminology, such as “top,” “bottom,” “front,” “back,” etc., is used with reference to the orientation of the figure(s) being described. Because components of the embodiments of the present invention can be positioned in a number of different orientations, the directional terminology is used for purposes of illustration and is in now way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

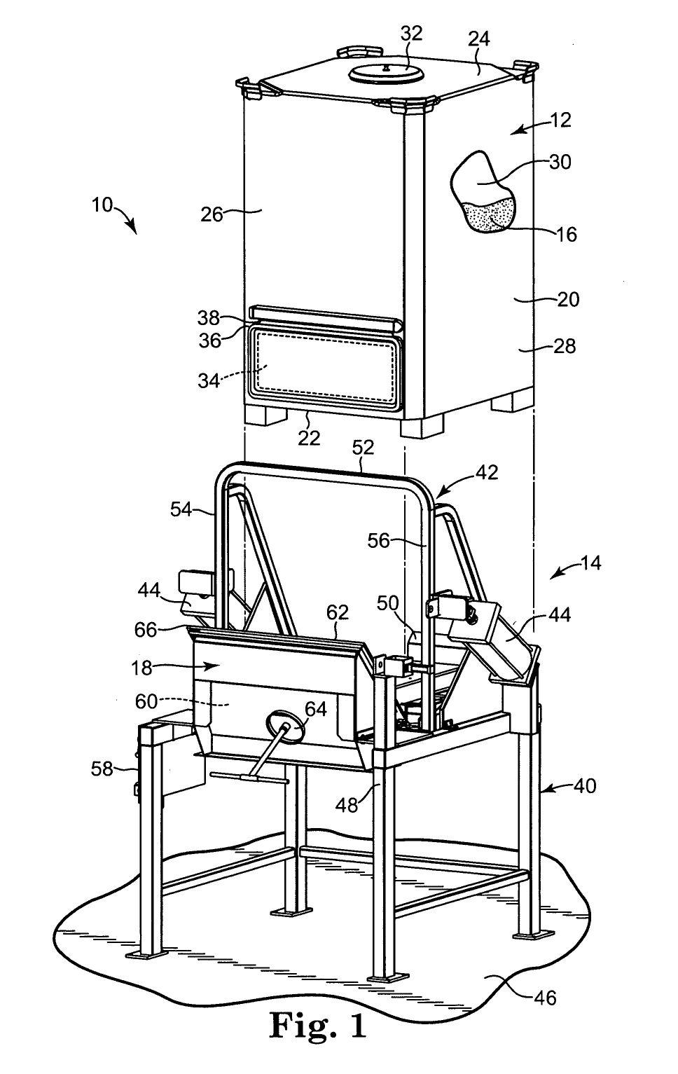

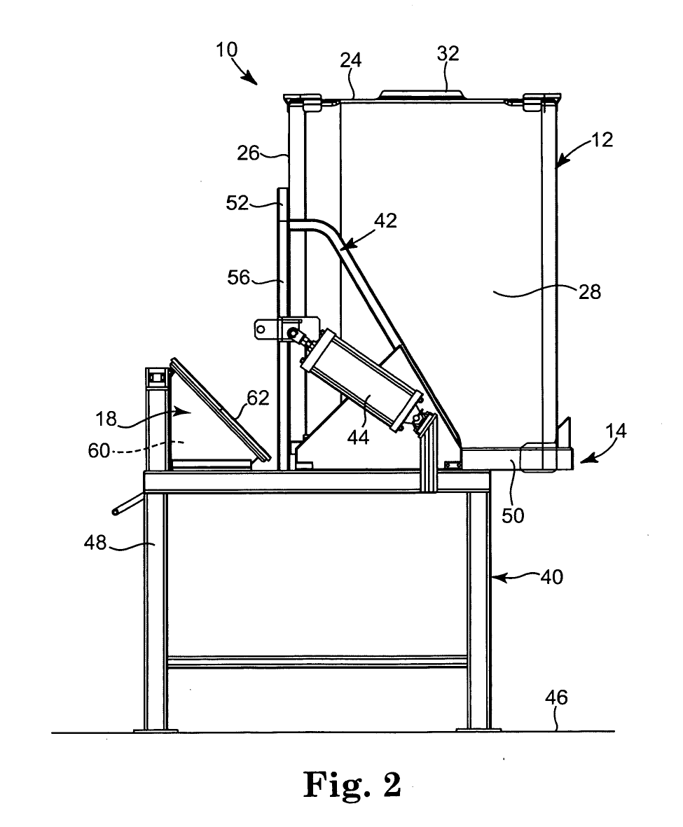

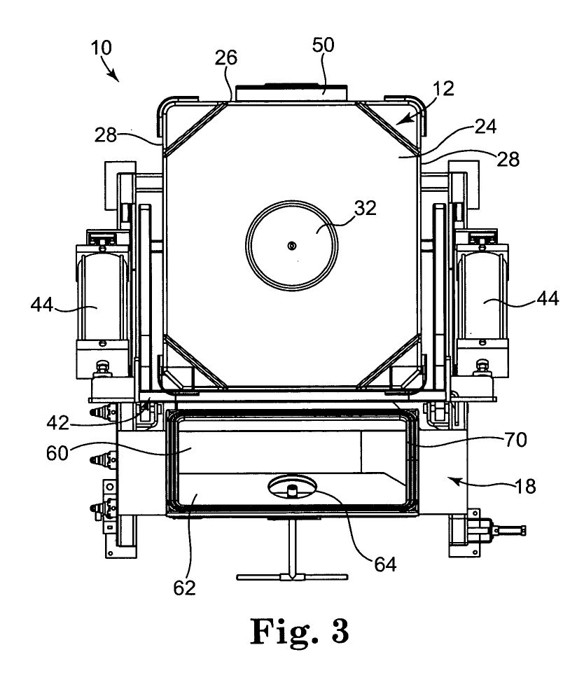

FIGS. 1-3 illustrate one embodiment of a bin discharge system generally at 10. Bin discharge system includes a storage container or bin 12 and a tilt discharge station 14. Bin 12 selectively houses or stores dry or powdered flowable bulk goods 16. During use, bin 12 is placed upon tilt discharge station 14, opened, and emptied into a transition hopper 18 of tilt discharge station 14. From transition hopper 18, goods are distributed as desired by the user. The now empty bin 12 is removed from tilt discharge station 14 and reused for storing additional dry or powdered goods 16.

Bin 12 is a storage container, such as for example, an intermediate bulk container (IBC) or tote bin. Accordingly, in one embodiment, bin 12 defines a body portion 20, a bottom panel 22, and a top panel 24. Body portion 20 includes opposing face panels 26 and opposing side panels 28. In one embodiment, each side panel 28 extends between face panels 26 to effectively form body portion 20 as an elongated and rectangular hollow structure. Face panels 26 and side panels 28 are preferably continuously formed with one another. In one embodiment, face panels 26 and side panels 28 are integrally formed with one another.

Bottom panel 22 extends between face panels 26 and side panels 28 at one end opening of body portion 20. Top panel 24 extends between face panels 26 and side panels 28 at the end opposite bottom panel 22. Accordingly, a compartment 30 is defined between body portion 20, bottom panel 22, and top panel 24. Compartment 30 is sized and shaped to receive a plurality of goods for storage, such as powdered or dry flowable bulk goods 16.

In one embodiment, top panel 24 includes an upper opening (not shown) with a removable upper lid 32. Upper lid 32 is removable such that the dry goods 16 can be dispensed through the upper opening and into compartment 30 for storage. Once goods 16 have been placed within compartment 30, upper lid 32 is placed back upon the upper opening to close the bin 12. One face panel 26 additionally defines a lower opening generally indicated at 34 near bottom wall 22 and a lower lid or cover 36. The lower opening 34 is sized and shaped to permit discharge of goods 16 from bin 12. In one embodiment, lower cover 36 fits about the lower opening 34 and is attached to face panel 26 via a hinge 38, such as a notched, curled, or piano-style hinge. Accordingly, lower cover 34 opens and closes by rotating about hinge 38.

Tilt discharge station 14 includes a base frame 40, transition hopper 18, a rotating frame 42, and an actuating device 44. In one embodiment, base frame 40 is formed of a metal, such as aluminum or steel, and is configured to be coupled with and support transition hopper 18, rotating frame 42, and actuating member 20. In particular, base frame 16 is adapted to interact with a floor or supporting member 46 and to interact with transition hopper 18 and rotating frame 42 opposite the floor 46.

Rotating frame 42 is also formed of fabricated metal such as aluminum or steel, and is configured to selectively receive bin 12. In particular, in one embodiment, rotating frame 42 includes a bottom support member 50, front support member 52, and side support members 54 and 56. Bottom support member 50 is configured to interact with bottom panel 22 of bin 12 to selectively support bin 12 in place above floor 46. Front support member 52 extends from bottom support member 50 and includes at least one portion configured to interact with face panel 26 of bin 12 to support bin 12 when placed in a tilted position as will be further described below.

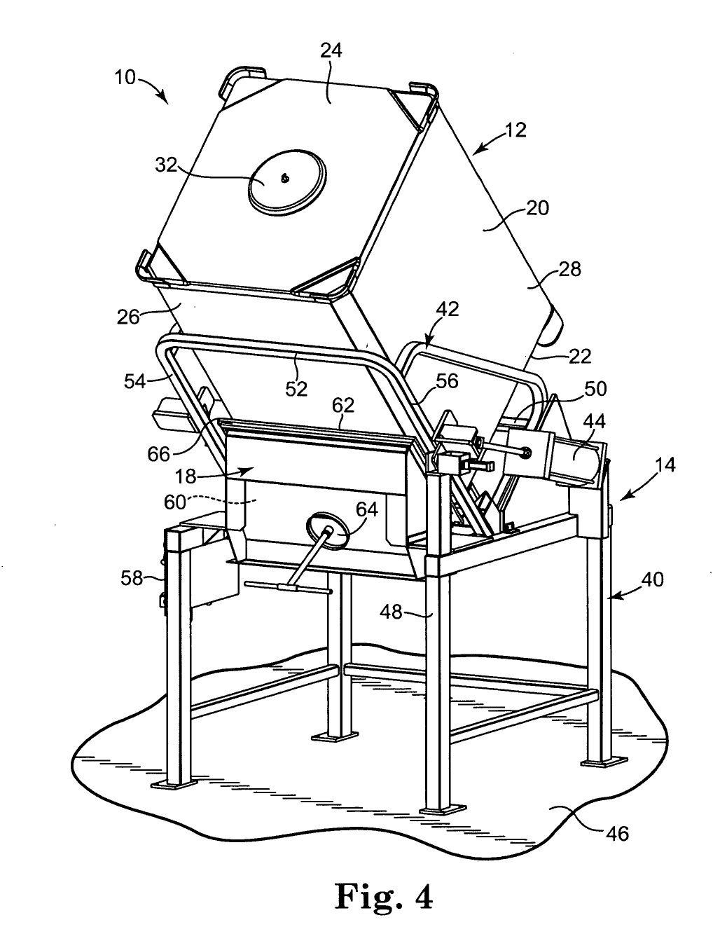

Side members 54 and 56 extend between front support member 52 and bottom support member 50 opposite one another to interact with side panels 28 of bin 12 to restrain side-to-side movement of bin 12 when retained by rotating frame 42. Accordingly, bottom, front, and side members 50, 52, 54, and 56 each interact with bin 12 to selectively maintain bin 12 within rotating frame 42. Rotating frame 42 is rotatably coupled with base frame 40 near the intersection of bottom support member 50 and front support member 52. With this in mind, rotating frame 42 rotates about that intersection from front to back of rotating frame 42 as illustrated with additional reference to FIG. 4.

Actuating device 44 is coupled between base frame 40 and rotating frame 42. In one embodiment, actuating device 44 includes one or a plurality of hydraulic cylinders which transition or rotate rotating frame 42 front to back, or in other words, from an upright position as illustrated in FIG. 1 to a tilted position as illustrated in FIG. 4. In one embodiment, tilt discharge station 14 additionally includes a control panel 58, which a user accesses to control actuating device 44.

Transition hopper 18 is attached to base frame 40 opposite a floor support surface 46 and near a front side 48 of base frame 40. Accordingly, transition hopper 18 is positioned in front of rotating frame 42. Transition hopper 18 defines an internal compartment 60 for receiving goods 16 from bin 12 and for further distributing these goods 16 as desired by the user. Accordingly, transition hopper 18 additionally defines an input opening 62 for receiving goods 16 and an output opening 64 opposite input opening 62 for dispensing goods 16. In one embodiment, input opening 62 is positioned at an angle to face upwards and towards the rear of base frame 40, i.e. toward rotating frame 42. In particular, in one embodiment, input opening 62 is positioned at an angle in the range of about 40° to 45° from a vertical reference line or with respect to front support member 52 when rotating frame 42 is in the upright position as illustrated in FIG. 1.

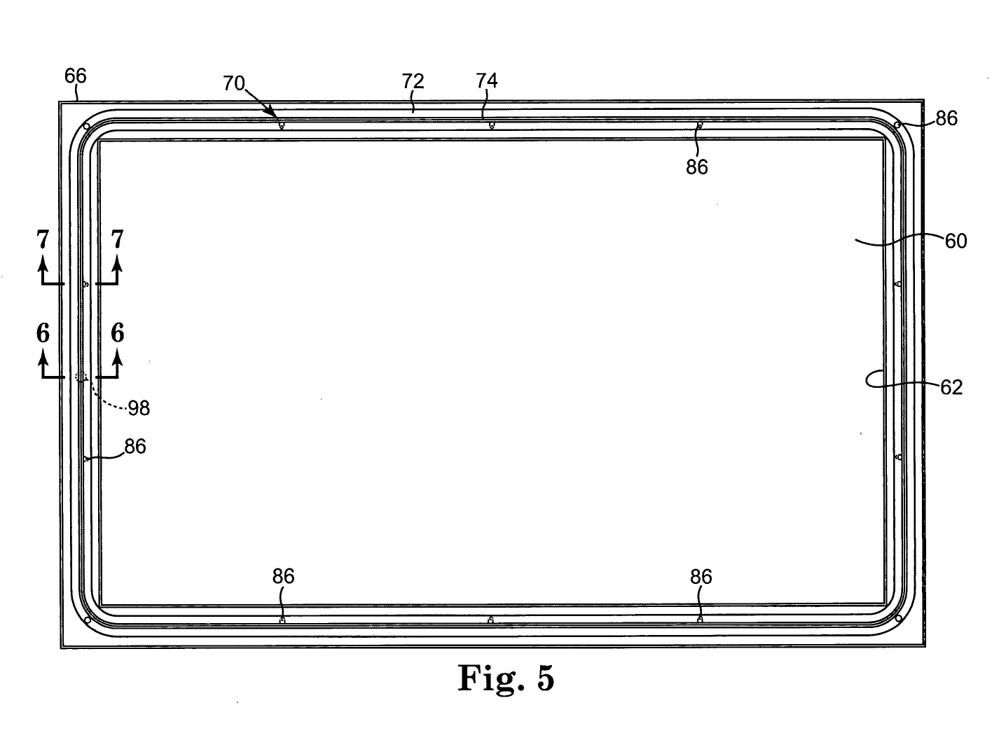

Additionally referring to FIG. 5, which is a plan view of transition hopper 18 from input opening 62, input opening 62 is more specifically defined by a steel or aluminum channel 66 extending about the periphery of input opening 62 and opened upwards. An inflatable seal 70 is fitted or provided within channel 66. In one embodiment, inflatable seal 70 includes a base 72 and an inflatable tube 74. Base 72 is shaped similar to and slightly larger than input opening 62 and placed within channel 66.

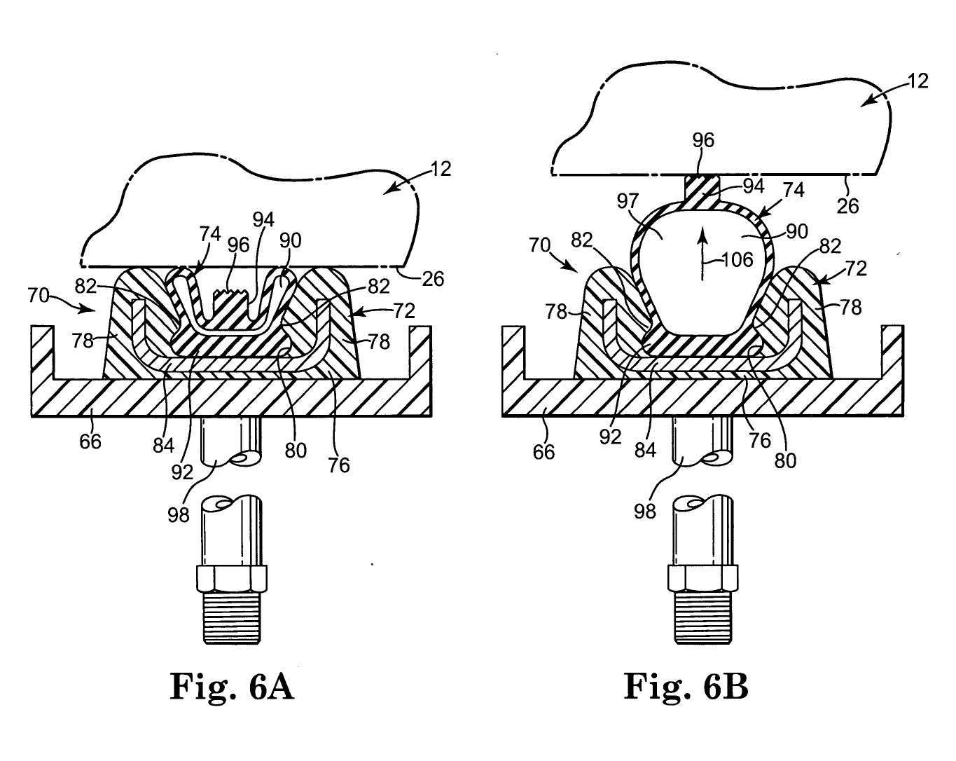

Additionally referring to FIGS. 6A and 6B, in one embodiment, the cross-section of base 72 is substantially channel or U-shaped. In particular, base 62 includes a planar bottom portion 76 and two retaining ridges 78 opposite one another. Planar bottom portion 76 and retaining ridges 78 extend about the entire length of each side of base 72. Retaining ridges 78 extend from planar bottom portion 76 opposite one another to define a retention groove 80 there between. In one embodiment, each retaining ridge 78 includes a tab or a protrusion 82 spaced from bottom portion 76 and extending into retention groove 80.

In one embodiment, base 72 is primarily formed of an elastomeric material, such as rubber, gasket material, etc. In one embodiment, base 72 is primarily formed of Ethylene Propylene Diene Monomer (EPDM) rubber. In one embodiment, base 72 additionally includes a rigid or semi-rigid insert 84 made of a substantially rigid material, which is embedded within or over-molded with the rubber or gasket material. In one embodiment, the insert 84 is substantially formed of steel. As illustrated in FIGS. 6A and 6B, insert 84 is substantially channel or U-shaped and, as such, extends throughout planar bottom portion 76 and up into each retaining ridge 78 of base 72. Insert 84 provides additional stability to base 72.

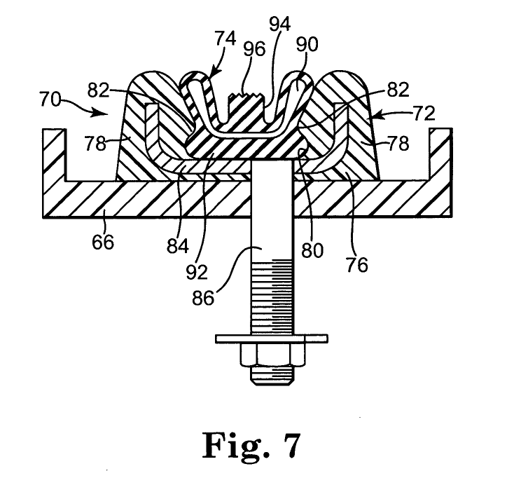

As illustrated in FIG. 5 with reference to the cross-sectional view of FIG. 7, in one embodiment, base 72 is coupled with channel 66 with a plurality of fasteners 86. For example, in one embodiment, each fastener 86 fits through a hole (not shown) formed within base 72 and through channel 66. In one embodiment, fasteners 86 are spaced along the entire length of base 72. In one embodiment, fasteners 86 are screws or threaded studs and nuts. It is understood, however, that other fastening coupling, or securing arrangements may be used to secure inflatable seal 70 to or position inflatable seal 70 in channel 66 of transition hopper 18.

Inflatable tube 74 is continuously formed to extend around input opening 62 within retention groove 80 of molded base 72. In particular, inflated tube 74 defines an inflation chamber 90, a flattened edge 92, and an sealing protrusion 94. Flattened edge 92 extends from one side of inflation tube 74 and is formed of a substantially thick concentration of elastomeric material through which inflation chamber 90 does not fully extend into. Accordingly, flattened edge 92 extends in a generally consistent manner whether or not inflation tube 74 is inflated or deflated. Sealing protrusion 94 extends from inflation tube 74 opposite flattened edge 92.

Sealing protrusion 94 is a thick or concentrated portion of elastomeric material extending upward from inflation chamber 90 to define an interface surface 96 for interacting with bin 12 as will be further described below. In one embodiment, interface surface 96 is overall generally planar, but is ridged to account for manufacturing defects. Inflation chamber 90 is configured to be selectively inflated with a fluid 97, such as pressurized air, and deflated by removal of the fluid 97.

Inflation tube 74 is coupled with base 72 by placing flattened edge 92 adjacent planar bottom portion 76 and retained within retention groove 80 below tabs 82 of retaining ridges 78. More specifically, tabs 82 pinch inflation tube 74 just above flattened edge 92 to secure flattened edge 92 between tabs 82 and bottom portion 76. Accordingly, inflation tube is coupled with base 72 by an interference fit. The remainder of inflation tube 74 extends between retaining ridges 78 above tabs 82. Flattened edge 92 is relatively rigid as compared to the remainder of inflation tube 74 in order to be consistently retained within retention groove 80 beneath tab 82 and to maintain coupling between base 72 and inflation tube 74 during periods of inflation and deflation alike.

When deflated, inflation tube 74 is maintained between retaining ridges 78 in a substantial “W” manner. In particular, weight of sealing protrusion 94 causes a middle portion of inflation tube 74 to extend downwardly due to the elastomeric nature of inflation tube 74. Once inflated, as illustrated in FIG. 6B, inflation chamber 90 is filled with fluid 97 and sealing protrusion 94 is transitioned away from flattened edge 92 to form a more nearly round or oval shaped cross-section of inflation tube 74. A supply line 98 extends through base 72 and into inflation chamber 90 at at least one portion of inflation chamber 90.

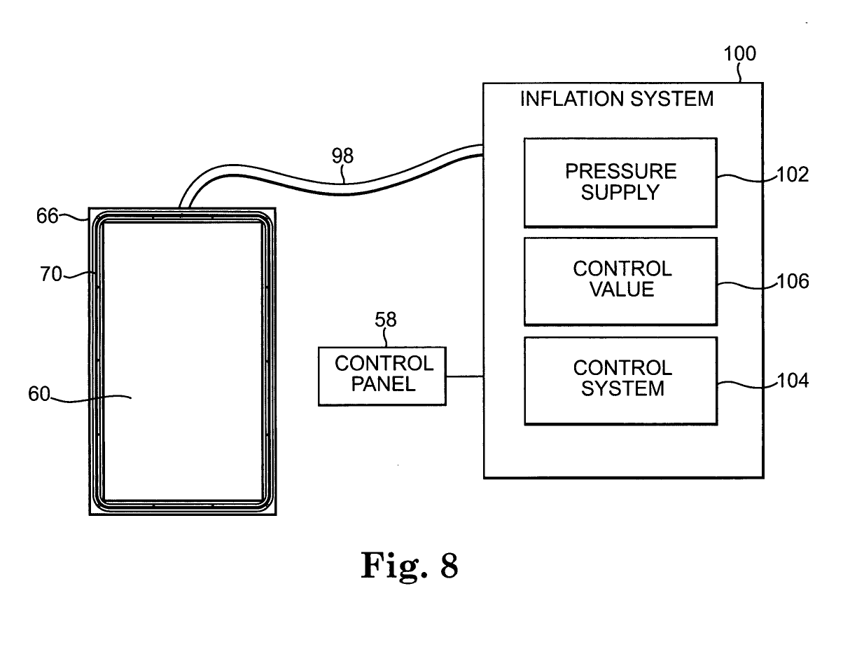

Additionally, referring to FIG. 8, supply line 98 couples inflation chamber 90 with inflation system 100, which provides a channel for pressurized fluid to be introduced to or removed from inflation chamber 90. As illustrated in FIG. 8, in one embodiment, inflation system 100 includes a pressure supply 102 and a control system 104. Pressure supply 102 is capable of pressurizing inflatable seal 70 by supplying fluid 97 to inflation chamber 90 and capable of depressurizing inflatable seal 70 by removing fluid 97 from inflation chamber 90. In one embodiment, pressure supply 102 is a pneumatic pump, such as an air compressor, or a hydraulic pump capable of providing fluid 97 to or removing fluid 97 from inflation chamber 90.

Control system 104 is electronically coupled with pressure supply 102 for controlling the actions of pressure supply 102. In particular, in one embodiment, control system 104 includes a processor for controlling the inflation and deflation of inflation chamber 90 per a predefined goods discharge process. Control system 104 is user accessible via control panel 58 of tilt discharge station 14 to allow a user to define when inflation chamber 90 should be inflated or deflated. In one embodiment, inflation system 100 additionally includes at least one control valve 106 including at least one regulator, filter, or other mechanism (not shown) to facilitate proper supply, regulation, and control of fluid 97 into and out of inflation chamber 90.

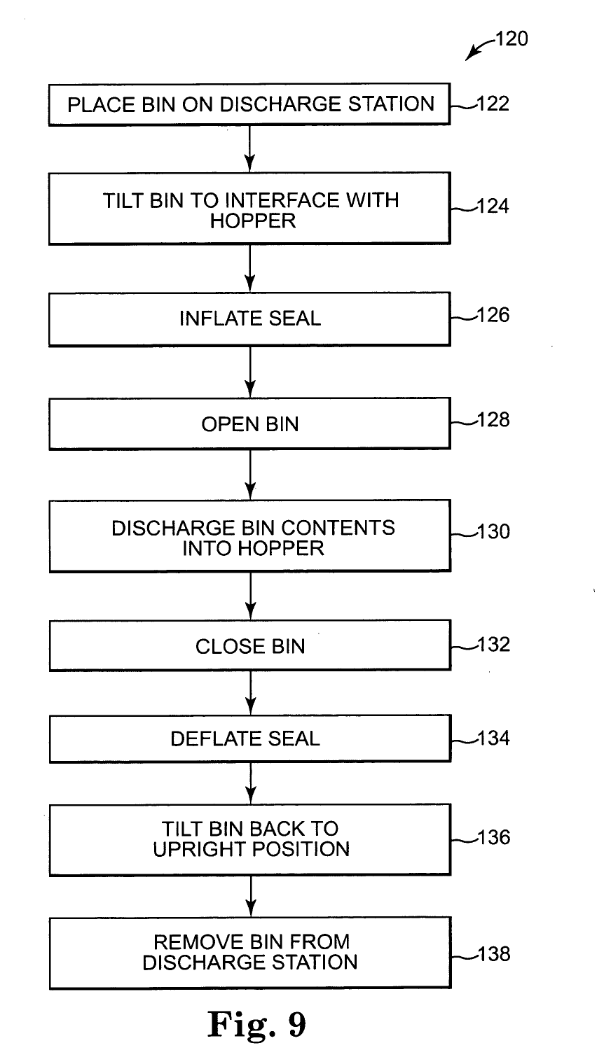

One embodiment of a process for discharging goods 16 from bin 12 is generally illustrated in FIG. 9 at 120. At 122, bin 12 is placed on rotating frame 42 of discharge station 14. In particular, bottom wall 22 of bin 12 is placed to interface with bottom support member 50 such that the entirety of the body portion 20 of bin 12 is positioned between side members 54 and 56 of rotating frame 42. Accordingly, face panel 26 including a lower opening 34 and lower lid 36 is placed to interface with front support member 52 of rotating frame 42. As such, lower opening 34 and lid 36 are positioned forward or toward front support member 52 and transition hopper 18.

At 124, actuating device 44 is moved to tilt rotating frame 42 about a pivot with base frame 40. In one embodiment, control panel 58 includes controls for activating rotation of actuating device 44. In one embodiment, in which actuating device 44 is one or a plurality of hydraulic cylinders, actuating device 44 is activated such that hydraulic cylinder pushes front support member 52 forward to rotate rotating frame 42 about base frame 40. Rotating frame 42 is rotated until the face panel 26 interacts with inflatable seal 80. In one embodiment, face panel 92 more specifically contacts inflatable seal 80 to interact with a portion of retaining ridges 78 opposite planar bottom portion 76 of seal 80 as illustrated in FIG. 6A. In one embodiment, in order to interact with transition hopper 18, rotating frame 42 rotates bin 12 to an angle of 45° as compared to its upright position.

Once bin 12 is tilted and positioned to interact with transition hopper 18, at 126, inflation chamber 90 is inflated. In particular, control system 104 actuates pressure supply 102 to supply fluid 97 to inflation chamber 90 via supply line 98. Inflation of inflation chamber 90 pushes sealing protrusion 94 away from flattened edge 92, as indicated by arrow 106 of FIG. 6B, and, therefore, upward and away from channel 66. As inflation chamber 90 is inflated, sealing protrusion 94 interacts with a surface of face panel 26 about the lower opening 34 and lower lid 36 of bin 12. Notably, the position of inflation tube 74 between retaining ridges 78 ensures substantially upward inflation of inflation chamber 90 rather than outward inflation of inflation tube 74 over retaining ridges 78. The upward inflation of inflation chamber 90 provides pressure on sealing protrusion 94 forcing sealing protrusion 94 into face panel 26 to form a relatively high integrity seal between face panel 26 and transition hopper 18. Fluid 97 inherently migrates within inflatable chamber 90 to adjust to accommodate manufacturing tolerances or defects of face panel 26 without decreasing the overall integrity of inflatable seal 70.

Once inflation chamber 90 is filled such that a relatively high integrity seal is formed between channel 66 and face panel 26, at 128, bin 12 is opened by rotating lower lid or cover 36 about hinge 38. As such, lower lid or cover 36 is opened within transition hopper 18. By sealing the interface between transition hopper 18 and face panel 26 of bin 12 prior to opening of lower lid 36, additional escape of the powder or dry goods 16 is prevented or at least decreased. Once bin 12 is opened, at 130, the contents or goods 16 within bin 12 are discharged into hopper 18. In particular, in one embodiment, hopper 18 is vibrated to vibrate bin 12 to facilitate flow of goods 16 out of bin 12. In particular, vibration prevents coagulation of powdered goods 16 or compact areas of powdered goods 16 from sticking within compartment 30 of bin 12. In one embodiment, vibration of transition hopper 18 is actuated upon user interface with control panel 58, namely a switch or button for actuating vibration of hopper 18.

Once the entire contents of bin 12 or a portion of contents of bin 12 as desired by the user are discharged into the transition hopper 18 and distributed as desired by the user through output opening 64, bin 12 is closed at 132 by rotating lower cover 36 about hinge 38 and securing cover 36 in a closed position over the lower opening 34. At 134, the inflatable seal 180 is deflated when control system 104 notifies pressure supply 102 to work in an opposite manner as during inflation to remove air or other fluid from inflation chamber 90. In other words, control system 104 notifies pressure supply 102 to depressurize inflatable seal 80. In one embodiment, action of control system 104 is implemented upon a user interaction with control panel 58.

At 136, actuating device 44 is activated to rotate rotating frame 42 back to an upright position, thereby rotating bin 12 back to the original upright position as illustrated in FIG. 1. In one embodiment, activation of actuating device 44 is initiated via user control with control panel 58. Once the now empty bin 12 is positioned in its original upright position, bin 12 is removed from the discharge station at 138. In one embodiment, a forklift or other machine or mechanism is used to place bin 12 on and remove bin 12 from discharge station 14. Once removed from discharge station 14, bin 12 can be reused for storage of other or similar goods 16. Following removal of bin 12 from discharge station 14, discharge station 14 is prepared for receiving other bins or containers containing dry or powdered flowable bulk goods for product dispersion.

An inflatable seal according to the present invention provides for a self-adjusting seal to accommodate manufacturing defects or other deformities in the bin that would otherwise cause gaps in the typical gasket seal between a transition interface hopper and the bin itself. By self-adjusting to accommodate such defects, the seal between the hopper and the bin has increased integrity, therefore, keeping a higher percentage of the powder or dust of the transferred goods within the transition hopper and out of the manufacturing environment. By decreasing the amount of dust particles in the manufacturing environment, machine performance is increased. In addition, decreased dust within the manufacturing environment also decreases the occurrence of health problems or other safety concerns to workers operating within the same manufacturing environment.

Although specific embodiments have been illustrated and described herein, it will be apparent to those of ordinary skill in the art that a variety of alternate and/or equivalent implementations may be substituted for the specific embodiments shown and described without departing from the scope of the present invention. This application is intended to cover any adaptations or variations of the specific embodiments discussed herein.

1. An inflatable seal for a bin discharge system including a bulk container and a discharge station, the inflatable seal comprising:
a tube defining an inflation chamber and secured about a periphery of an opening of the discharge station; and
a fluid adapted to be introduced into the inflation chamber, wherein a quantity of the fluid within the inflation chamber is adjustable to selectively form a seal between the bulk container and the discharge station.

2. The inflatable seal of claim 1, wherein the fluid includes air.

3. The inflatable seal of claim 1, wherein the tube is formed of an elastomeric material.

4. The inflatable seal of claim 3, wherein the elastomeric material includes an Ethylene Propylene Diene Monomer (EPDM) rubber.

5. The inflatable seal of claim 1, wherein the quantity of the fluid within the inflation chamber is adjustable to inflate and deflate the tube, wherein when the tube is inflated, the tube forms the seal between the bulk container and the discharge station, and when the tube is deflated, the tube does not form the seal between the bulk container and the discharge station.

6. The inflatable seal of claim 1, wherein the tube includes a sealing protrusion adapted to interface about a periphery of an opening of the bulk container.

7. The inflatable seal of claim 6, wherein the sealing protrusion extends from the tube and defines a ribbed surface opposite the periphery of the opening of the discharge station.

8. The inflatable seal of claim 1, further comprising:
a base coupled about the periphery of the opening of the discharge station, wherein the base defines a groove adapted to receive the tube such that a sealing surface is defined by the tube opposite the groove, and further wherein the sealing surface is configured to interface with the bulk container.

9. The inflatable seal of claim 8, wherein the tube includes a flattened edge secured within the groove of the base.

10. The inflatable seal of claim 9, wherein the base includes protrusions extending into the groove, wherein the protrusions interact with the flattened edge of the tube and secure the tube with the base.

11. The inflatable seal of claim 8, wherein the base is formed of an elastomeric material.

12. The inflatable seal of claim 8, wherein the base includes a substantially rigid insert embedded within the base.

13. The inflatable seal of claim 12, wherein the substantially rigid insert includes steel.

14. The inflatable seal of claim 1, wherein the tube has a substantially W-shaped cross-section when the tube is deflated.

15. The inflatable seal of claim 1, wherein the tube has one of a substantially round-shaped cross-section and a substantially oval-shaped cross-section when the tube is inflated.

16. The inflatable seal of claim 1, further comprising:
a supply line communicated with the inflation chamber of the tube, wherein the supply line is adapted to direct the fluid to and from the inflation chamber.

17. An inflatable seal for a transition hopper of a bin discharge station, the transition hopper including a face having an opening defined therein, the inflatable sealing comprising:
a base positioned around a periphery of the opening in the face of the transition hopper;
an inflatable tube mated with the base; and
a pressure supply line communicated with the inflatable tube,
wherein the pressure supply line is adapted to supply pressurized air to the inflatable tube to selectively inflate and deflate the inflatable tube.

18. The inflatable seal of claim 17, wherein the transition hopper has a channel formed in the face thereof around the periphery of the opening, wherein the base of the inflatable seal is fitted within the channel.

19. The inflatable seal of claim 17, wherein the base of the inflatable seal has an insert embedded therein, wherein the inflatable seal is secured to the transition hopper via the insert.

20. The inflatable seal of claim 17, wherein the inflatable tube includes a portion secured within the base and a sealing surface opposite the portion secured within the base.

21. A discharge station for use with a storage bin, the discharge station comprising:
a transition hopper including an input opening; and
an inflatable seal secured about the input opening of the transition hopper and defining an inflation chamber adapted to maintain a pressurized fluid,
wherein the discharge station is adapted to position the storage bin adjacent the transition hopper for interaction with the inflatable seal, and
wherein the pressurized fluid is adapted to be introduced to the inflation chamber to inflate the inflatable seal and form a seal between the storage bin and the transition hopper, and wherein the pressurized fluid is adapted to be removed from the inflation chamber to deflate the inflatable seal and remove the seal between the storage bin and the transition hopper.

22. The discharge station of claim 21, wherein the inflatable seal includes an inflatable tube and a base is secured about the input opening of the transition hopper, the base defining a groove configured to receive a portion of the inflatable tube and the inflatable tube defining the inflation chamber.

23. The discharge station of claim 22, wherein the inflatable tube defines a flattened edge secured within the groove of the base.

24. The discharge station of claim 23, wherein the base defines protrusions extending into the groove, wherein the protrusions interact with the flattened edge of the inflatable tube and secure the inflatable tube with the base.

25. The discharge station of claim 22, wherein the base includes a substantially rigid insert embedded within the base.

26. The discharge station of claim 21, further comprising:
an inflation system communicated with the inflatable seal and configured to control inflation and deflation of the inflatable seal.

27. An inflatable seal for a bin discharge system including a bulk container and a tilt discharge station, the inflatable seal comprising:
means for maintaining a variable quantity of a pressurized fluid;
means for securing the means for maintaining the pressurized fluid about a periphery of an opening of the tilt discharge station; and
means for increasing and decreasing a quantity of the pressurized fluid maintained within the means for maintaining the pressurized fluid;
wherein the quantity of the pressurized fluid is increased to establish a seal between the bulk container and the tilt discharge station, and decreased to remove the seal between the bulk container and the tilt discharge station.

28. A method of forming a seal between a storage bin and a discharge station, the method comprising:
providing an inflatable seal about a periphery of an opening of the discharge station;
positioning the storage bin on the discharge station, including aligning an opening of the storage bin with the opening of the discharge station;
inflating the inflatable seal, including introducing a pressurized fluid into the inflatable seal and forming a seal between the storage bin and the discharge station; and
deflating the inflatable seal, including removing the pressurized fluid from the inflatable tube and removing the seal between the storage bin and the discharge station.

29. The method of claim 28, wherein inflating the inflatable seal includes changing a cross-sectional profile of the inflatable seal and forcing the inflatable seal against a periphery of the opening of the storage bin.
